(19) United States
(12) Patent Application Publication
(10) Pub. No.: US 2016/0043979 A1
(43) Pub. Date: Feb. 11, 2016

(54) AUTOMATIC BIOGRAPHICAL SUMMARY COMPILATION AND SPEAKER RECOGNITION BASED MESSAGING SYSTEM

(71) Applicant: FaceToFace Biometrics, Inc., Saint Louis, MO (US)

(72) Inventor: Scott Stern, Saint Louis, MO (US)

(21) Appl. No.: 14/819,269

(22) Filed: Aug. 5, 2015

Related U.S. Application Data
(60) Provisional application No. 62/033,499, filed on Aug. 5, 2014.

(51) Int. Cl. H04L 12/58; H04W 12/06; H04L 29/08; H04W 4/12

(52) U.S. Cl. CPC H04L 51/16; H04W 4/12; H04W 12/06; H04L 67/306

(57) ABSTRACT

Some embodiments include a messaging platform to facilitate delivery of message conversations between user accounts. The messaging platform can store at least a subset of the message conversations in a data storage memory. The messaging platform can implement a data destruction policy configured to specific which of the message conversations are to be queued for deletion from the data storage memory. Based on the stored conversations, the messaging platform can generate a biographical summary of a user account based on portions of archived message conversations in the data storage memory.

### CROSS-REFERENCE To RELATED APPLICATIONS

This application claims the benefit of U.S. Provisional Patent Application No. 62/033,499, filed Aug. 5, 2014, which is incorporated by reference herein in its entirety.

### RELATED FIELD

At least one embodiment of this disclosure relates generally to an electronic messaging system, and in particular to archival of electronic messages and security of a messaging application.

### BACKGROUND

Because of the widely availability of mobile devices, in some areas/cultures electronic messaging is becoming an integral part of a person's life. Some messaging systems have a default setting of archiving all electronic messages. Archival of electronic messages has various advantages. For example, electronic messages may have intrinsic social value, such as sentimental values associated with nostalgia. Electronic messages may also have informational value in accessing important business or personal records embedded within content of the electronic messages. The users can choose to delete an electronic message manually for privacy purposes and to free up digital storage space.

In some alternative messaging systems, the default setting is digitally destroying every electronic message after a certain time has expired. Because messaging systems usually take a rather black and white approach in terms of archival versus destruction, most people have to choose between privacy or convenience, however not both.

Further, security of a messaging system is fast becoming an essential concern to protect one's privacy from the public or any other prying eyes. Conventional technology protects against privacy violations by providing a screen lock on a mobile device whenever the mobile device is not used. An authorized user can unlock the screen by typing in a passcode into the mobile device. However, the passcode is knowledge that is transferable, and hence may be stolen. Furthermore, the screen lock prevents access to other applications on the mobile device, making it unnecessarily inconvenient.

### BRIEF DESCRIPTION OF THE DRAWINGS

FIG. 1 is a block diagram of a system environment of a messaging system implementing a biographical summarizer, in accordance with various embodiments.

FIG. 2 is an example of a biographical summary, in accordance with various embodiments.

FIG. 3 is a block diagram of a system environment of a messaging system implementing speaker recognition based security, in accordance with various embodiments.

FIG. 4 is a flow chart of a method of operating a mobile device implementing a biometric-based virtual cover for its messaging application, in accordance with various embodiments.

FIG. 5 is a block diagram of an example of a computing device, which may represent one or more computing device or server described herein, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

### Biographical Summary

The technology relates to generating a “curatable” and searchable biographical summary (e.g., a timeline) describing critical events in a person's life based on messages sent to and from the person using a user account through a messaging system. “Curatable,” in this context, refers to the ability for an authorized use to store, search, edit, modify, delete, and/or annotate the content in the biographical summary. The biographic timeline can include text, photo, GIFs, audio clips, and videos from message conversations. The messaging system can implement a default self-destruct mechanism for each message and/or each conversation. The messaging system can be implemented by a messaging application running on a computing device. The messaging application can provide an easy way to stop the self-destruct mechanism from occurring.

The messaging system can implement a summarizer engine to select the message conversations to include in the biographical summary. The summarizer engine can select specific portions of the message conversations to include in the biographical summary. The summarizer engine can further extract context from the selected message conversations to include in the biographical summary.

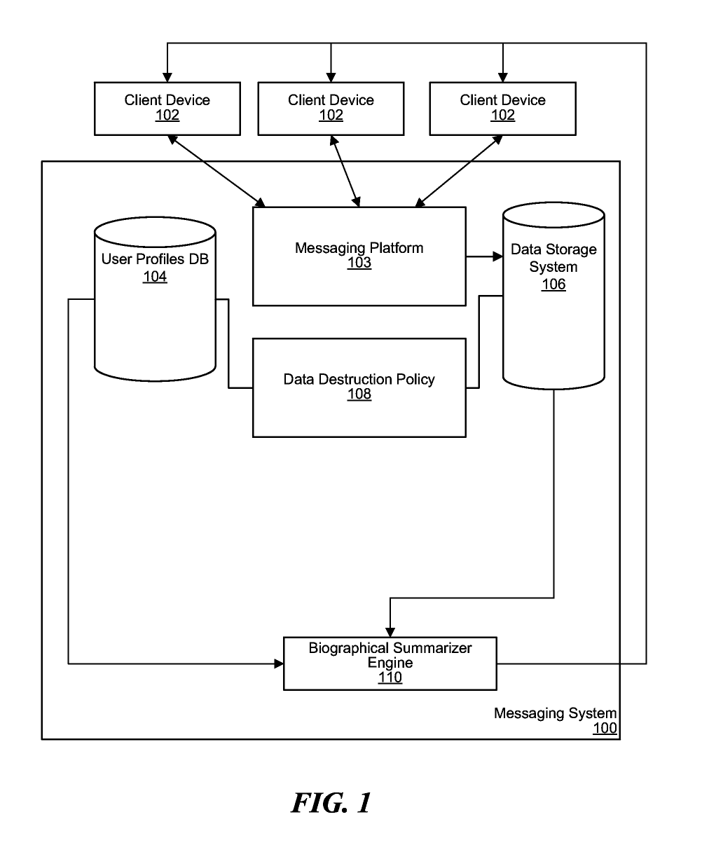

FIG. 1 is a block diagram of a system environment of a messaging system 100 implementing a biographical summarizer, in accordance with various embodiments. The messaging system 100 can communicate with client devices 102 (e.g., mobile phones, tablets, desktop computers, laptops, other network-enabled devices, or any combination thereof). The messaging system 100 can include a messaging platform 103 configured to provide a service to facilitate human understandable electronic communication between user accounts. The human understandable electronic communication can include emoticons, text, photos, audio clips, videos, links, images, or any combination thereof. The human understandable content of the electronic communication may be part of an electronic message or can be referenced in the electronic message (e.g., stored elsewhere that is accessible through a network).

In some embodiments, each of the client devices 102 can have an instance of a messaging application running thereon that communicates with the messaging platform 103. For example, some of the client devices 102 can install an application (e.g., mobile application) in an operating system of the client devices. In another example, some of the client devices 102 can access a web-based application through web browsers on those client devices.

The client devices 102 are associated with user accounts. In some embodiments, a user account can have multiple client devices associated therewith. In some embodiments, a client device can have multiple user accounts associated therewith. Conversations between user accounts are tracked by the messaging system 100 such that the messaging system 100 can deliver an electronic message from a client device of one user account to a client device of another user account.

In some embodiments, the messaging system 100 can include a user profile database 104. The user profile database 104 is configured to store user profiles of one or more user accounts. The user profiles may be associated with one or more social networking systems (e.g., an affiliated social networking system, a social networking system integrated with the messaging system 100, or an external social networking system) and social network profiles in the social networking systems.

In some embodiments, the messaging system 100 can include a data storage system 106 configured to archive at least some of the electronic messages between user accounts. The messaging system 100 can implement cryptographic measures to protect the storage of these electronic messages (e.g., including its content and metadata).

The messaging system 100 may be configured to protect the privacy of the user accounts by enforcing a data destruction policy 108. The data destruction policy 108 can be implemented by one or more methods of data deletion of a memory space, including, for example, labeling the memory space as “freed” in an operating system of the data storage system 106, overriding the memory space (e.g., “zeroing out” the memory space), making a cryptographic key used to decrypt content of the memory space inaccessible, or any combination thereof. In some embodiments, the data destruction policy 108 may also include implementing the one or more methods of data deletion on the client devices 102, such as via the messaging application (e.g., as an agent application of the messaging system 100).

In some embodiments, at least part of the data destruction policy 108 can be implemented across the user accounts. For example, the data destruction policy 108 can have a default setting to delete the message conversations stored in the data storage system 106 after a threshold expiration duration. The data destruction policy 108 can also have a default setting specific to a particular type of user account, a particular context of a message conversation, a particular type of content in a message conversation, or any combination thereof.

For example, the default setting can be based on a privacy tolerance level of the user accounts. Each user account may be associated with a privacy tolerance level (e.g., stored in the user profile). A computing device authenticated as operated by the user account can set the privacy tolerance level. In some embodiments, the messaging system 100 can implement a machine learning algorithm to estimate the privacy tolerance level of the user accounts. The data destruction policy 108 can adjust whether or not to delete the message conversations of the user accounts depending on the privacy tolerance levels of those user accounts.

For another example, the default setting can be based on the social context between the participants of a message conversation. For example, message conversations between socially connected user accounts (e.g., according to the social networking system) can be saved while message conversations involving user accounts that are not socially connected may be queued for deletion.

For yet another example, the default setting can be based on content in the message conversations. In some embodiments, whenever the memory space required for storing the content exceeds a threshold, the content is queued for deletion. In some embodiments, whenever the content is detected as spam, illegal data, malware, other undesirable content, or any combination thereof, the content is queued for deletion.

In some embodiments, at least part of the data destruction policy 108 can be implemented specific to each of the user accounts and configurable by the user accounts. These user specified rules become part of the data destruction policy 108. The user account can specify rules across all message conversations, rules particular to context of message conversations, or content in the message conversations.

The messaging system 100 can include a biographical summarizer engine 110. The biographical summarizer engine 110 is configured to generate a biographical summary of a user account based on archived message conversations involving the user account. In some embodiments, the biographical summarizer engine 110 can include all of the message conversations to generate a detailed summary. In other embodiments, the biographical summarizer engine 110 can include only a subset of the message conversations involving the user account.

The biographical summarizer engine 110 can organize the biographical summary based on a timeline, based on a social graph of the user account, based on content type, based on who are involved in the message conversations, or any other rules specified by the user account or by the messaging system 100. The biographical summarizer engine 110 can present the biographical summary in the messaging application on the client devices 102. The biographical summarizer engine 110 can update the biographical summary in real-time as additional message conversations are stored into the data store system 106. Alternatively, the biographical summarizer engine 110 can instead update the biographical summary asynchronously, such as periodically.

The biographical summarizer engine 110 can analyze the message conversations, including analyzing metadata, context, and content of the message conversations, to determine whether or not to include a message conversation in the biographical summary. For example, the biographical summarizer engine 110 can include message conversations from a family member or a significant other. For another example, the biographical summarizer engine 110 can select a message conversation to include based on a total time of engagement (e.g., how long the user account is actively using the messaging application during the message conversation), a ratio of participation from the user account in the message conversation (e.g., the user account responded frequently in the message conversation), a length of the message conversation (e.g., measured by time or amount of content), or any combination thereof. For yet another example, the biographical summarizer engine 110 can select the message conversation to include based on the type of content in the message conversation. The biographical summarizer engine 110 can prefer photos and video clips over text and emoticon. The biographical summarizer engine 110 can prefer higher resolution multimedia content over lower resolution multimedia content. The biographical summarizer engine 110 can prefer multimedia content involving the user account or a social connection of the user account. For example, the biographical summarizer engine 110 can perform facial recognition on the photos and videos or speaker recognition on the audio clips to identify who are involved.

The biographical summary can include the entire message conversation, a portion of the message conversation, context of the message conversation (e.g., including “you messaged John for the first time,” without including the content of that message to John), or any combination thereof, based on the analysis. For example, the biographical summary can include a specific sentence (e.g., text that optionally includes emoticon, or an audio clip), a photograph, an image, a video, or any combination thereof. The biographical summarizer engine 110 can choose what portion of the selected message conversation to include based on the available content in the message conversation, metadata involving each portion of the message conversation, and social context involving each portion of the message conversation.

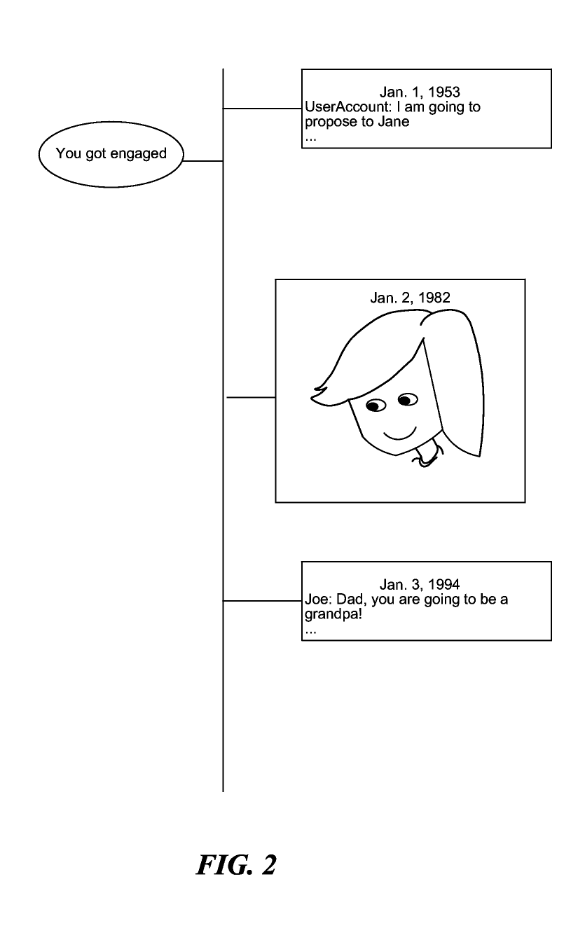

FIG. 2 is an example of a biographical summary, in accordance with various embodiments.

### Speaker Recognition Based Messaging System

Disclosed is a technology that pertains to protecting a messaging application via a biometric security mechanism, such as speaker recognition. The disclosed technology can be implemented by a messaging application running on a client device facilitated by a messaging server system in communication with the messaging application. The messaging application can present a user interface for users to send human understandable messages, including for example, text, emoticon, photos, images, audio clips, video clips, or any combination thereof. The messaging application can implement a virtual cover on the user interface implementing the biometric security mechanism.

The virtual cover, for example, can determine whether or not an authorized user is present by listening for an audio input from the user. The messaging system can maintain biometric profiles of user accounts. For every electronic message sent through the messaging system, a destination associated with a user account is specified. That user account is thus considered an authorized user to view the electronic message. In some embodiments, the sender account is also considered an authorized user. In some embodiments, the sender account, the receiver account, or both can add additional user accounts into a list of authorized users. In some embodiments, the sender account, the receiver account, or both can add one or more user accounts into a list of “blacklisted” user accounts that are expressly unauthorized (as to user accounts that are implicitly unauthorized by not being on the list of authorized users).

The virtual cover can reveal content of a message conversation when an authorized user is detected to be operating the messaging application. In some embodiments, the virtual cover can hide the content in response to detecting both an authorized user and an unauthorized user (e.g., implicitly unauthorized or expressly unauthorized). In some embodiments, the virtual cover can hide the content whenever an expressly unauthorized user account is detected.

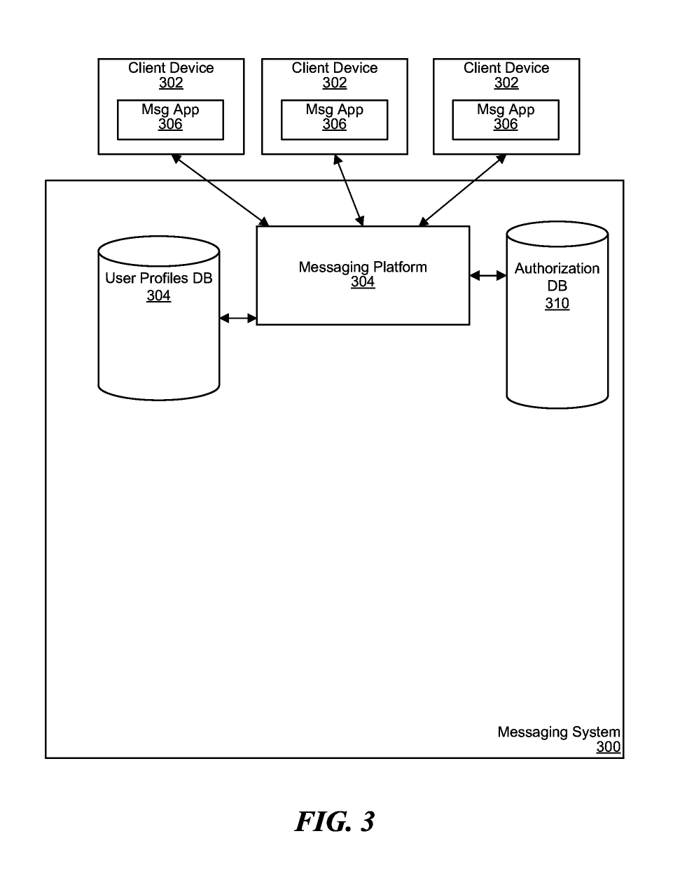

FIG. 3 is a block diagram of a system environment of a messaging system 300 implementing speaker recognition based security, in accordance with various embodiments. The messaging system 300 can communicate with client devices 302 (e.g., mobile phones, tablets, desktop computers, laptops, other network-enabled devices, or any combination thereof). The messaging system 300 can include a messaging platform 304 configured to provide a service to facilitate human understandable electronic communication between user accounts. The human understandable electronic communication can include emoticons, text, photos, audio clips, videos, links, images, or any combination thereof. The human understandable content of the electronic communication may be part of an electronic message or can be referenced in the electronic message (e.g., stored elsewhere that is accessible through a network).

In some embodiments, each of the client devices 302 can have an instance of a messaging application 306 running thereon that communicates with the messaging platform 304. For example, the messaging application 306 can be embodied as a mobile application running on operating systems of some of the client devices 302. In another example, some of the client devices 302 can access a web-based application through web browsers on those client devices.

The client devices 302 are associated with user accounts. In some embodiments, a user account can have multiple client devices associated therewith. In some embodiments, a client device can have multiple user accounts associated therewith. Conversations between user accounts are tracked by the messaging system 300 such that the messaging system 300 can deliver an electronic message from a client device of one user account to a client device of another user account.

In some embodiments, the messaging system 300 can include a user profile database 308. The user profile database 308 is configured to store user profiles of one or more user accounts. The user profiles may be associated with one or more social networking systems (e.g., an affiliated social networking system, a social networking system integrated with the messaging system 300, or an external social networking system) and social network profiles in the social networking systems.

In various embodiments, the messaging application 306 can implement a virtual cover. The messaging application 306, for example, can detect whether or not an authorized user is present by listening for an audio input from the user (e.g., via respective microphones on the client devices 302). The messaging system can maintain biometric profiles of user accounts in the user profile database 308. The messaging platform 304 associates a sender account and a receiver account with every message (e.g., as specified by the sender account). The biometric profiles of the sender account and the receiver account can be both considered “authorized users.” One or more lists of authorized users may be stored in an authorization database 310. The authorization database 310 can also maintain one or more lists of blacklisted user accounts that are explicitly unauthorized. In some embodiments, the sender account, the receiver account, or both can add additional user accounts into the list of authorized users. In some embodiments, the sender account, the receiver account, or both can add one or more user accounts into the list of “blacklisted” user accounts.

The authorization database 310 can store a list of authorized user specific to a message conversation or specific to a user account (e.g., specific to a sender account, a receiver account, or both). For example, for each message sent or each message received, a user can add or remove one or more accounts from the list of authorized users or blacklisted users. For another example, a first user account can add a second user account as an authorized user (e.g., a spouse) or a blacklisted user (e.g., a rival friend or sibling) for all conversations that the first user account participates in. In some embodiments, e.g., as required by law, the authorization database 310 can also store a list of globally authorized users.

The messaging platform 304 can communicate with the messaging application 306 to implement the virtual cover (e.g., sending biometric profiles of the authorized users and/or expressly unauthorized users to be verified or requesting the messaging application 306 to send an audio clip of its operator to be verified on the messaging system 300). The virtual cover implemented by the messaging application 306 can reveal content of a message conversation when the authorized user is detected. In some embodiments, the virtual cover can hide the content in response to detecting both an authorized user and an unauthorized user (e.g., implicitly unauthorized or expressly unauthorized). In some embodiments, the virtual cover can hide the content whenever an expressly unauthorized user account is detected.

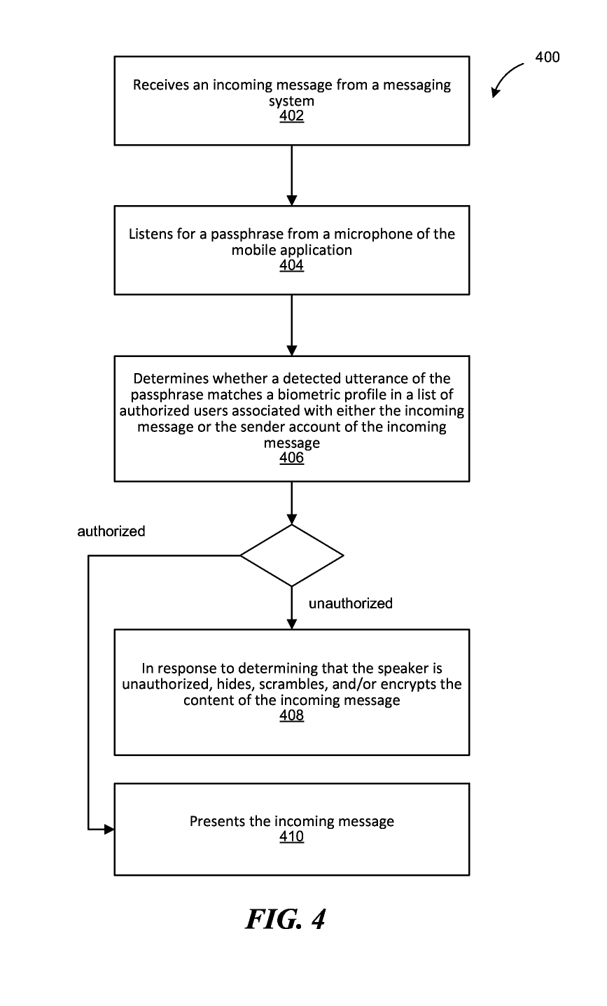

FIG. 4 is a flow chart of a method 400 of operating a mobile device implementing a biometric-based virtual cover for its messaging application, in accordance with various embodiments. This method may apply to other devices other than mobile devices. In step 402, the mobile device can receive an incoming message from a messaging system (e.g., the messaging system 300 of FIG. 3). In step 404, the messaging application listen for a passphrase from a microphone of the mobile device. In some embodiments, step 404 may be after the messaging application presents (e.g., via a display of the mobile device) a request via the messaging application for a user to speak a passphrase. In some embodiments, the passphrase may be a passphrase specified by a sender account of the incoming message. In this case, the messaging application may run both voice recognition and speaker recognition to verify the receiver account. In some embodiments, the passphrase may be the same for a group of users (e.g., users in a geographical region, users in a social network group, users that speak a certain language, or any other grouping) or all users of the messaging system. For example, the passphrase may be “open sesame.”

The use of the same passphrase for a group of users or all users is advantageous in branding the messaging system. Further, the messaging system can select a passphrase as part of a marketing campaign. For example, “Fastfood ABC” may be a restaurant chain that would like to market itself through the messaging system. The messaging system can thus select the passphrase based on its marketing affiliates, such as the restaurant chain. For example, the passphrase may be “Mmm ABC is delicious.” This forces users of the messaging application and the messaging system to become part of a viral marketing campaign by uttering the passphrase whenever accessing a message conversation. In various embodiments, the passphrase is selected to be short and easy to pronounce.

In some embodiments, the messaging application can determine whether the passphrase has been uttered by running voice recognition on the input stream of the microphone. In some embodiments, the messaging application can present a user interface component (e.g., a button on the user interface) to signal when the user is beginning to utter the passphrase and/or when the user stops uttering the passphrase. For example, the user can hold the button down while uttering the passphrase. The detected utterance may be truncated into an audio clip.

At step 406, the messaging application can determine whether the detected utterance of the passphrase matches a biometric profile (e.g., a speaker profile) in a list of authorized users associated with the incoming message or the sender account of the incoming message. For example, the messaging application can send the detected utterance to the messaging system to run a speaker recognition algorithm against the biometric profiles associated with the list of authorized users and/or the list of blacklisted users. Alternatively, the messaging application can receive the biometric profiles associated with the list of authorized users and/or the list of blacklisted users from the messaging system. Then, the messaging application can run the speaker recognition algorithm against the known biometric profiles. At the end of step 406, the messaging application would know whether the speaker of the passphrase is authorized, explicitly unauthorized, or implicitly unauthorized.

In response to determining that the speaker is unauthorized, the messaging application then hides, scrambles, and/or encrypts the content of the incoming message in step 408. In some embodiments, the messaging application can show some metadata or context relating to the incoming message. In other embodiments, the messaging application hides all data relating to the incoming message. If the speaker is determined to be authorized, then the incoming message is presented on the mobile device in step 410.

In some embodiments, the messaging application authenticates the speaker only once whenever the user of the mobile device is continuously using the messaging application (e.g., once authenticated, the user needs not to speak the passphrase again) without exiting, hiding, backgrounding, and/or minimizing the messaging application. In other embodiments, the messaging application may request the user to speak the passphrase again according to a schedule or in response to incoming messages.

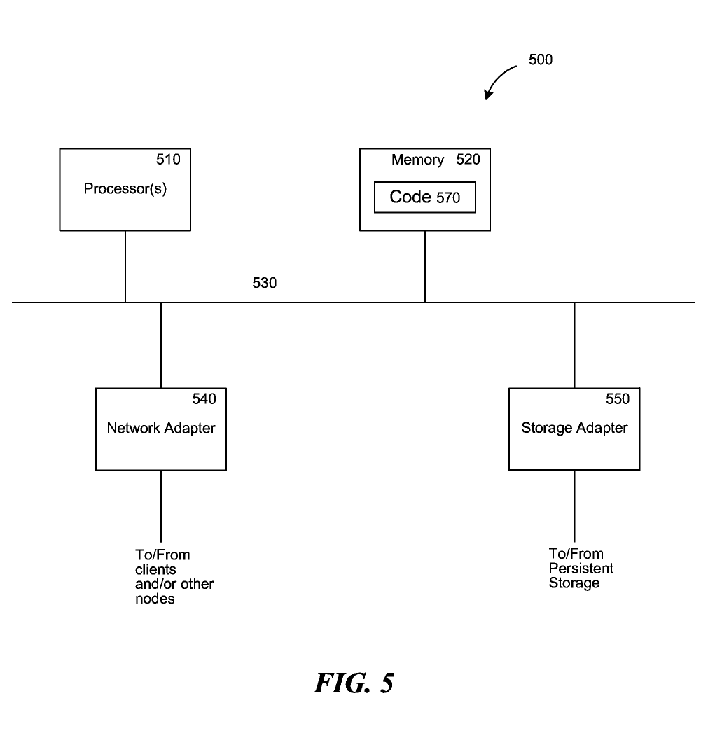

FIG. 5 is a block diagram of an example of a computing device 500, which may represent one or more computing device or server described herein, in accordance with various embodiments. The computing device 500 can be one or more computing devices that implement the messaging system 100 of FIG. 1 or the messaging system 500 of FIG. 5. The computing device 500 includes one or more processors 510 and memory 520 coupled to an interconnect 530. The interconnect 530 shown in FIG. 5 is an abstraction that represents any one or more separate physical buses, point-to-point connections, or both connected by appropriate bridges, adapters, or controllers. The interconnect 530, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1594 bus, also called “Firewire”.

The processor(s) 510 is/are the central processing unit (CPU) of the computing device 500 and thus controls the overall operation of the computing device 500. In certain embodiments, the processor(s) 510 accomplishes this by executing software or firmware stored in memory 520. The processor(s) 510 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 520 is or includes the main memory of the computing device 500. The memory 520 represents any form of random access memory (RAM), read-only memory (ROM), flash memory, or the like, or a combination of such devices. In use, the memory 520 may contain a code 570 containing instructions according to the mesh connection system disclosed herein.

Also connected to the processor(s) 510 through the interconnect 530 are a network adapter 540 and a storage adapter 550. The network adapter 540 provides the computing device 500 with the ability to communicate with remote devices, over a network and may be, for example, an Ethernet adapter or Fibre Channel adapter. The network adapter 540 may also provide the computing device 500 with the ability to communicate with other computers. The storage adapter 550 enables the computing device 500 to access a persistent storage, and may be, for example, a Fibre Channel adapter or SCSI adapter.

The code 570 stored in memory 520 may be implemented as software and/or firmware to program the processor(s) 510 to carry out actions described above. In certain embodiments, such software or firmware may be initially provided to the computing device 500 by downloading it from a remote system through the computing device 500 (e.g., via network adapter 540).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification.

What is claimed is:

1. A messaging system implemented by one or more computing devices including one or more processors, comprising:
a messaging platform engine configured to facilitate delivery of message conversations between user accounts, each associated with one or more computing devices and configured to store at least a subset of the message conversations in a data storage memory;
a data destruction policy configured to specific which of the message conversations are to be queued for deletion from the data storage memory; and
a biographical summarizer engine configured to generate a biographical summary of a user account based on portions of archived message conversations in the data storage memory.

2. A method of operating a messaging application on a computing device, comprising:
receiving an incoming message from a messaging system;
listening for a passphrase from a microphone of the computing device;
determining whether a detected utterance of the passphrase matches a biometric profile in a list of authorized users associated with the incoming message or the sender account of the incoming message; and
in response to determining that the speaker of the detected utterance is unauthorized, hiding the incoming message from output devices of the computing device.
